(19) United States
(12) Patent Application Publication
(10) Pub. No.: US 2024/0152970 A1
(43) Pub. Date: May 9, 2024

(54) CONTENT DISPLAY METHOD AND CONTENT DISPLAY SYSTEM

(71) Applicant: SHARP KABUSHIKI KAISHA, Osaka (JP)

(72) Inventor: TAKASHI YAMAMOTO, Osaka (JP)

(21) Appl. No.: 18/380,866

(22) Filed: Oct. 17, 2023

(30) Foreign Application Priority Data
Nov. 4, 2022 (JP) 2022-177166

(51) Int. Cl. G06Q 30/0251; G06Q 30/0272; H04W 8/24

(52) U.S. Cl. CPC G06Q 30/0267; G06Q 30/0255; G06Q 30/0272; H04W 8/24

(57) ABSTRACT

A content display method includes receiving terminal identification information transmitted from a mobile terminal to a signage display serving as a content display device by short-range wireless communication, and displaying content corresponding to the terminal identification information on the content display device. The content display system includes the mobile terminal and the signage display serving as the content display device. The signage display includes a receiver that receives terminal identification information transmitted from the mobile terminal by short-range wireless communication, and a display that displays content corresponding to the terminal identification information received by the receiver.

### INCORPORATION BY REFERENCE

The application claims priority based on 35 U.S.C. § 119 from Japanese Patent Application No. 2022-177166 filed on Nov. 4, 2022, the entire disclosure of which is incorporated herein.

### BACKGROUND

The present disclosure relates to a content display method and a content display system for distributing content to digital signage or the like, and more particularly, to a content display method and a content display system for distributing content that matches interests of viewers.

According to the digital signage distribution system described in Japanese Unexamined Patent Application Publication No. 2013-161360, a management server specifies an ID of digital signage located in the vicinity of a plurality of mobile terminals based on information received from the mobile terminals, acquires attribute information of users, extracts a type of content corresponding to the largest number of attributes, and transmits the type of content to a content distribution server. The content distribution server receives the signage ID and the type of the content from the management server, and transmits data of the content corresponding to the type to the digital signage.

### SUMMARY

According to an aspect of the present disclosure, a content display method includes receiving terminal identification information transmitted from a mobile terminal to a content display device by short-range wireless communication, and displaying content corresponding to the terminal identification information on the content display device.

According to another aspect of the present disclosure, a content display system includes a mobile terminal and a content display device. The content display device includes a receiver that receives terminal identification information transmitted from the mobile terminal by short-range wireless communication, and a display that displays content corresponding to the terminal identification information received by the receiver.

### BRIEF DESCRIPTION OF THE DRAWINGS

FIG. 1 is a block diagram illustrating a configuration of a content display system according to an embodiment of the present disclosure.

FIG. 2 is a functional block diagram of a signage display and a server.

FIG. 3 is a sequence diagram illustrating an operation of transmitting viewing information by the signage display.

FIG. 4 is a sequence diagram illustrating an operation of making an inquiry of preference information by the signage display.

### DETAILED DESCRIPTION

An embodiment of the present disclosure will be described with reference to the accompanying drawings. Note that, in the drawings, the same reference signs are given to the same or similar components, and the description of such components will not be repeated.

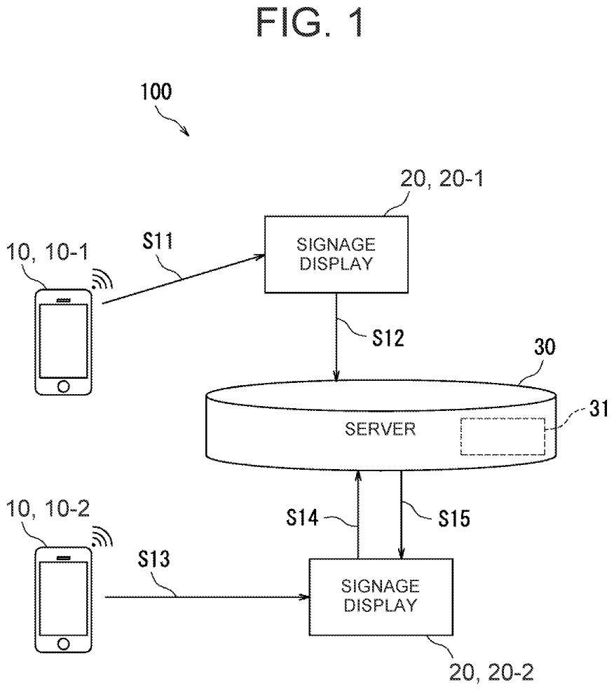

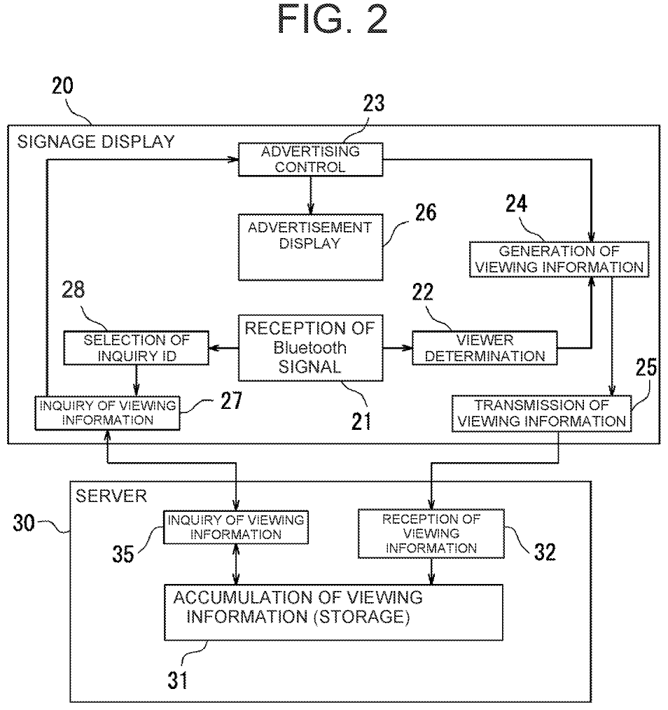

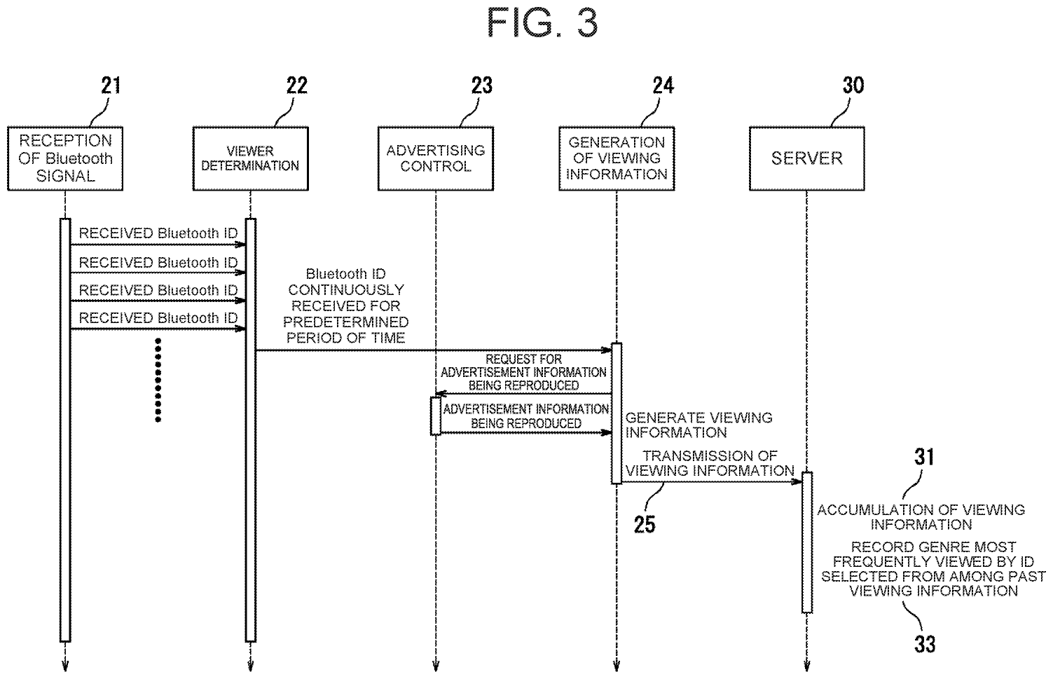

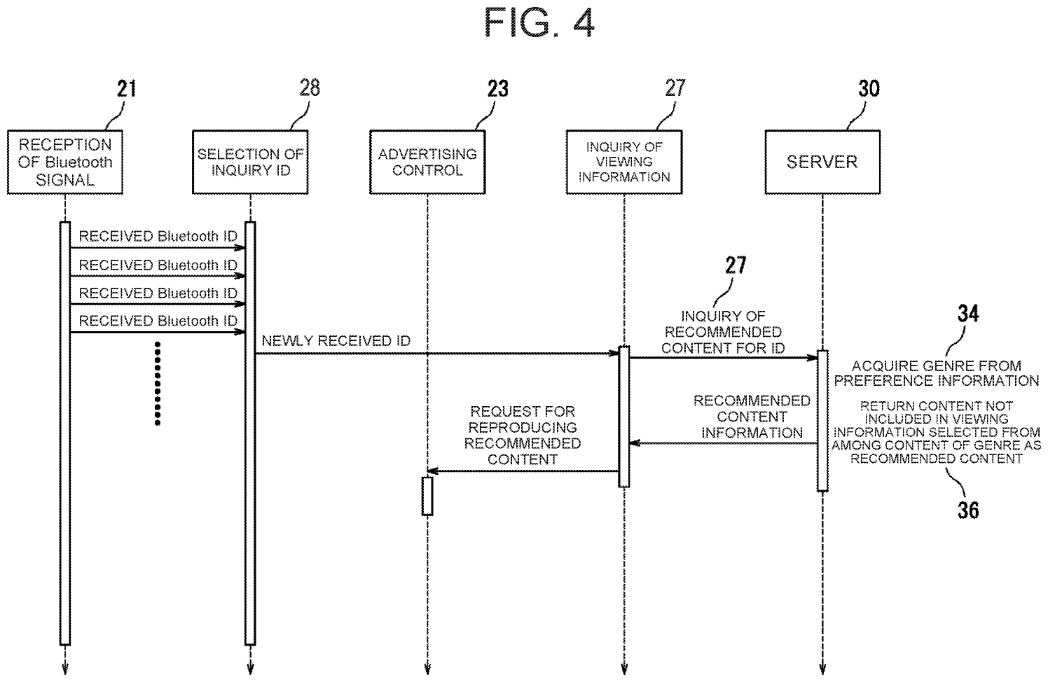

FIG. 1 is a block diagram illustrating a configuration of a content display system 100 according to an embodiment of the present disclosure. FIG. 2 is a functional block diagram of a signage display 20 and a server 30. FIG. 3 is a sequence diagram illustrating an operation of transmitting viewing information by the signage display 20. FIG. 4 is a sequence diagram illustrating an operation of making an inquiry of preference information by the signage display 20.

### 1.1 Configuration of Content Display System 100

As illustrated in FIG. 1, the content display system 100 includes a plurality of signage displays 20 that display content, such as advertisements, a server 30 that manages and distributes content, and mobile terminals 10 that are individually held by various viewers. Note that the signage displays 20 are examples of a “content display device” of the present disclosure.

Although the two signage displays 20 and the two mobile terminals 10 are illustrated in FIG. 1, the number of signage displays 20 and the number of mobile terminals 10 are not limited to two, and the number of signage displays 20 and the number of mobile terminals 10 are not always the same. Note that reference numerals, such as signage displays 20-1 and 20-2, are used only when the individual signage displays 20 need to be distinguished from each other. Similarly, reference numerals, such as the mobile terminals 10-1 and 10-2, are used only when the individual mobile terminals 10 need to be distinguished from each other.

As the mobile terminal 10, smartphones capable of performing short-range wireless communication, such as Bluetooth (registered trademark; notes are omitted in the following occurrences), are used. However, the present disclosure is not limited to this. Furthermore, the short-range wireless communication is not limited to Bluetooth, and ZigBee (registered trademark), Wi-Fi (registered trademark), or the like may be used.

Examples of the signage display 20 include, but are not limited to, a digital signage having a screen, such as a liquid crystal screen or an organic electro-luminescence (EL) screen.

The server 30 includes a storage 31, manages and stores various types of content to be displayed on the signage display 20 according to genres, and also stores a distribution target list of content, a distribution schedule, and the like. The server 30 further distributes content to the signage display 20 included in the distribution target list in accordance with the stored distribution schedule. By this, the signage display 20 can display not only a single type of content but also a plurality of types of content in order, or can switch the content at a predetermined time point.

### 1.2 Operation of Collecting Content Viewing Information of Viewers

As shown in an upper side in FIG. 1, a right side in FIG. 2, and FIG. 3, the signage display 20 receives an advertising signal transmitted from a Bluetooth device, such as the mobile terminal 10, that are near an installation location of the signage display 20 (S11 in FIGS. 1 and 21 in FIGS. 2 and 3). Note that this reception corresponds to “receiving” of the present disclosure. The reference numeral 21 in FIG. 2 is an example of a “receiver” of the present disclosure.

Examples of the advertising signal include, but are not limited to, an advertising packet from the Bluetooth device. However, it is preferable that the signal is automatically and periodically (for example, at a constant time interval) transmitted without requiring any operation.

When a certain signal is continuously received for a certain period of time (for example, 30 seconds or 1 minute), it may be determined that an owner of the Bluetooth device transmitting the signal does not simply pass through the vicinity of the installation location of the signage display 20, but stays in the vicinity and views content displayed on the signage display 20 (22 in FIGS. 2 and 3). Therefore, the signage display 20 detects unique terminal identification information included in the signal as an ID for identifying the owner of the Bluetooth device (the viewer of the content).

Examples of the terminal identification information include, but are not limited to, a media access control (MAC) address unique to the Bluetooth device. However, for example, a name that can be easily changed and that is mostly simple, such as a device name of Bluetooth, is not so preferable as the terminal identification information.

The signage display 20 requests advertisement information (one or a plurality of types of content) reproduced while the ID is detected (to 23 in FIGS. 2 and 3), and generates viewing information (viewing history) using the acquired advertisement information and the detected ID (24 in FIGS. 2 and 3). The signage display 20 transmits the viewing information thus generated to the server 30 (S12 in FIGS. 1 and 25 in FIGS. 2 and 3). Note that, when the displayed content is originally distributed from the server 30, the content itself is not required to be transmitted, and content identification information for specifying the content may be transmitted instead.

Every time the viewing information transmitted from the signage display 20 is received (32 in FIG. 2), the server 30 stores and accumulates the viewing information in the storage 31 (31 in FIGS. 2 and 3). Note that the storage and the accumulation correspond to “storing” of the present disclosure.

The server 30 further aggregates the accumulated viewing information by focusing on the ID. Specifically, for each ID, a genre of content that is the most frequently viewed is set as a genre of preference for the ID, and the ID and the genre are recorded as preference information (33 in FIG. 3). However, the above is merely an example, and the information recorded as the preference information is not limited to the genre, and includes other attribute information of the content.

Note that, when the content is originally distributed from the server 30 and the content identification information is transmitted from the signage display 20, it is also recorded that the content has been viewed by the ID.

### 1.3 Operation of Displaying Content According to Preference of Viewer

As shown in a lower side in FIG. 1, a left side in FIG. 2, and FIG. 4, the signage display 20 receives a signal transmitted from the Bluetooth device, such as the mobile terminal 10, that is near the installation location (S13 in FIGS. 1 and 21 in FIGS. 2 and 4), similarly to the case of S11 (FIG. 1) described above.

The signage display 20 detects terminal identification information included in the signal as an ID for identifying an owner of the Bluetooth device. An ID of a Bluetooth device detected immediately before is compared with an ID of a Bluetooth device newly detected, and the ID of the Bluetooth device newly detected is used for making an inquiry of recommended content in order to discriminate a person who has viewed the content immediately before from a person who newly views the content and to distribute the recommended content to the person who newly views the content (28 in FIGS. 2 and 4). Note that the term “immediately before” as used herein is not limited to a timing of an immediately preceding ID detection, and may include a timing of an ID detection within a certain period of time (for example, 10 seconds or 30 seconds) immediately before. The signage display 20 further makes an inquiry of recommended content for the owner of the Bluetooth device having the ID by transmitting the ID to the server 30 (S14 in FIGS. 1 and 27 in FIGS. 2 and 4).

The server 30 receives the inquiry about the viewing information from the signage display 20 (35 in FIG. 2). The server 30 searches the viewing information accumulated in the storage 31 for viewing information having the same ID as the ID of the Bluetooth device transmitted from the signage display 20. When the target viewing information is found, the server 30 acquires a preference genre corresponding to the ID based on the preference information including the ID (34 in FIG. 4), and selects one of a large number of items of content belonging to the genre. However, the above is merely an example, and the method for selecting the recommended content may be changed in accordance with an acquirer for acquiring the preference information. For example, an algorithm similar to an algorithm for introducing a recommended product based on a purchase history and a browsing history of a user may be used, or viewing information and preference information of other persons having a similar preference may be referred to in addition to viewing information of the user, as is employed in some mail-order sites.

In a case where whether each content has been viewed is recorded, one of items of content that are not viewed by the ID may be selected. However, content that has already been viewed may dare to be selected in order to strongly impress the viewer. In this way, the recommended content for the ID is selected, and the content itself or the content identification information is returned to the signage display 20 (S15 in FIGS. 1 and 36 in FIG. 4).

When the recommended content itself or the content identification information thereof is returned from the server 30, the signage display 20 performs control of displaying the recommended content (23 in FIGS. 2 and 4 and 26 in FIG. 2). Note that such display control corresponds to “displaying” of the present disclosure. The reference numeral 26 in FIG. 2 is an example of a “display” of the present disclosure.

With this configuration, even when an owner of a smartphone or the like does not perform any active action, such as some sort of operation, content matching the preference of the owner may be automatically displayed on the nearby signage display 20. As a result, an advertisement effect may be enhanced by the signage display 20.

1. A content display method, comprising:
receiving terminal identification information transmitted from a mobile terminal to a content display device by short-range wireless communication; and
displaying content corresponding to the terminal identification information on the content display device.

2. The content display method according to claim 1, wherein, in the displaying, the content display device displays the content corresponding to the terminal identification information continuously received for a predetermined period of time.

3. The content display method according to claim 1, further comprising storing, as a viewing history, the terminal identification information received in the receiving, and the content displayed on the content display device when the terminal identification information is received or content identification information of the content.

4. The content display method according to claim 3, wherein the displaying displays the content selected based on the viewing history including the same terminal identification information as the terminal identification information among the viewing histories stored in the storing.

5. The content display method according to claim 1, wherein the terminal identification information is identification information unique to the mobile terminal included in an advertising signal transmitted from the mobile terminal.

6. A content display system including a mobile terminal and a content display device, wherein
the content display device includes
a receiver that receives terminal identification information transmitted from the mobile terminal by short-range wireless communication, and
a display that displays content corresponding to the terminal identification information received by the receiver.
